(19) United States
(12) Patent Application Publication
(10) Pub. No.: US 2014/0306965 A1
(43) Pub. Date: Oct. 16, 2014

(54) MULTI-DIRECTIONAL VIRTUAL PAGE NAVIGATION ANIMATION

(71) Applicant: MICROSOFT CORPORATION, Redmond, WA (US)

(72) Inventors: Chia-Huei Yen, Bellevue, WA (US); Robert Frye, Seattle, WA (US); Salvador Celis, Seattle, WA (US)

(73) Assignee: Microsoft Corporation, Redmond, WA (US)

(21) Appl. No.: 13/860,456

(22) Filed: Apr. 10, 2013

(51) Int. Cl. G06T 13/00

(52) U.S. Cl. CPC G06T 13/00
USPC 345/473

(57) ABSTRACT

Architecture that enables a page/content animation user experience where new pages and/or new content can be exposed in any one of multiple directions using an animated unfolding behavior. The unfolding behavior can be performed on a page or piece of content, between pages or pieces of content, on a diagonal, and other directions, and can be performed based on a fold axis that is visually presented as being a forward position or a rear position along with corresponding visual effects. One or more pages of content are presented in a viewport of display, and an interaction gesture is detected relative to the one or more pages. An animation component animates the unfolding behavior at an unfolding location relative to the one or more pages in the viewport to expose new pages. The unfolding behavior is enabled in response to the interaction gesture.

### BACKGROUND

There are limited page navigation paradigms available for designers and developers to implement. Scrolling between pages and replicating a real world page turn are more common existing examples, which leave developers with little room to create new experiences. In addition, this traditional way of displaying a page turn is often seen as behind the times where a digital screen is replicating a real world metaphor.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables a page/content animation user experience where new pages and/or new content can be exposed using an animated unfolding behavior. The new pages/content can be unfolded into currently presented pages/content of the viewport. The unfolding behavior can be performed on a page or piece of content, between pages or pieces of content, on a diagonal, and other directions. The unfolding behavior can be performed based on a fold axis that is visually presented as being a forward position or a rear position along with corresponding visual effects.

One or more pages of content are presented in a viewport of display, and an interaction gesture is detected relative to the one or more pages. An animation component animates the unfolding behavior at an unfolding location relative to the one or more pages in the viewport to expose new pages. The unfolding behavior is enabled in any one of multiple directions, in response to the interaction gesture.

The interaction gesture indicates the unfolding location between two pages of the one or more pages and the animation component animates the unfolding behavior of the new pages between the two pages. Additionally, the interaction gesture indicates the unfolding location in a page of the one or more pages and the animation component animates the unfolding behavior of the new pages in the page. The unfolding behavior is relative to a fold axis of the new pages. The unfolding behavior is animated based on the fold axis appearing forward in the viewport or away from the viewport.

The multiple directions include vertically, horizontally, and diagonally, and the multiple directions are enabled between pages of the one or more pages or in a page of the one or more pages. The unfolding behavior is animated to expose a new page in visual abutment to two of the one or more pages. The unfolding behavior partially or entirely displaces at least one page of the one or more pages in the viewport with the new pages.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a diagram of right-to-left motion and animation for a user experience in accordance with the disclosed architecture.

FIG. 3 illustrates a diagram of left-to-right motion and frontward fold axis animation for a user experience in accordance with the disclosed architecture.

FIG. 4 illustrates a diagram of left-to-right motion and rear fold animation for a user experience in accordance with the disclosed architecture.

FIG. 5 illustrates a diagram of right-to-left motion and rear fold axis animation for a user experience in accordance with the disclosed architecture.

FIG. 6 illustrates a diagram of top-to-bottom motion and rear fold axis animation for a user experience in accordance with the disclosed architecture.

FIG. 7 illustrates a diagram of diagonal and rear unfolding animation for a user experience in accordance with the disclosed architecture.

FIG. 8 illustrates a diagram of a vertical split page (or unfold from within another page) and rear fold animation for a user experience in accordance with the disclosed architecture.

FIG. 9 illustrates a diagram of a horizontal split page (or unfold from within another page) and fold animation of a rear fold for a user experience in accordance with the disclosed architecture.

FIG. 10 illustrates a diagram of fold animation where unfolding occurs along two other pages.

FIG. 11 illustrates a diagram of fold animation where two hands can be used to indicate folding of one page and unfolding of new pages.

FIG. 12 illustrates a method in accordance with the disclosed architecture.

FIG. 13 illustrates an alternative method in accordance with the disclosed architecture.

FIG. 14 illustrates a block diagram of a computing system that executes animated fold animation in accordance with the disclosed architecture.

### DETAILED DESCRIPTION

The disclosed architecture creates a new user experience for presenting new pages and/or content in display. The architecture enables a page/content fold animation user experience where new pages and/or new content can be exposed in any one of multiple directions using an animated unfolding behavior.

In operation, an interaction gesture is detected (received) relative to content (or pages) presented in a viewport of a display. An unfolding behavior of new content is animated in response to the interaction gesture. The unfolding behavior can be performed along an edge of the content, in the content, or between two items of different content, for example.

The architecture creates a user experience that animates an unfolding behavior by exposing some or all of new pages concurrently relative to a fold axis. The unfolding behavior is animated as associated with a fold axis that appears forward in the viewport or back in the viewport. The unfolding behavior can be animated in one of the one or more pages to expose the new pages. The unfolding behavior can be animated as visually abutting one of the one or more pages to expose the new pages. The unfolding behavior can be animated in response to the interaction gesture interpreted as moving one page of the one or more pages away from the unfolding location. The unfolding behavior can be animated along a diagonal of the viewport to expose the new pages, and vertically or horizontally in the viewport to expose the new pages.

In another implementation, the interaction gesture is detected relative to content presented in a viewport of a display. The unfolding behavior of new content is animated in response to the interaction gesture. The unfolding behavior is performed along an edge of the content, in the content, or between two items of different content. The unfolding behavior of the new content is animated along a fold axis that is one of vertical, horizontal, or diagonal. Some or all of the content is displaced with the new content based on the interaction gesture. The unfolding behavior can be animated to visually perceive the new content as abutting the content on one edge of the content, as abutting the content on two edges of the content, or abutting the two items content on opposing edges of the two items of content. The unfolding behavior can also be animated as unfolding toward the viewport or unfolding away from the viewport.

Note that as used herein, the phrase “fold animation” is intended to mean the general notion of creating, preparing, and handling virtual folds; thus, “unfolding” is a type of fold animation, as is “folding” a type of fold animation. However, unfolding relates specifically to an opening operation to expose more of a page or the content of the page, and folding refers specifically to a closing operation that closes pages or covers page content. A fold axis refers to an axis about which either folding or unfolding is performed. A single page can be folded such that two parts of the page overlap. Two different pages can connect at (be affixed to) the fold axis, and rotate about the fold axis to fold or unfold. Similarly, a single page can be folded to create the fold axis at the fold and, fold and unfold at the fold axis.

The architecture exposes pages us the unfolding behavior in any direction, left-right, up-down, and in any portion of the page—full or partial. When a user is presented with a user interface (UI) on a touch or non-touch sensitive device, the user is able to navigate through the content by swiping or clicking left or right, at which point the UI unfolds to reveal the rest of the page content. The content itself is created by either stitching a series of (mappable) images or coded content. The animation can be achieved by using JavaScript™ and/or cascading style sheet (CSS), but is not limited to this code base.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

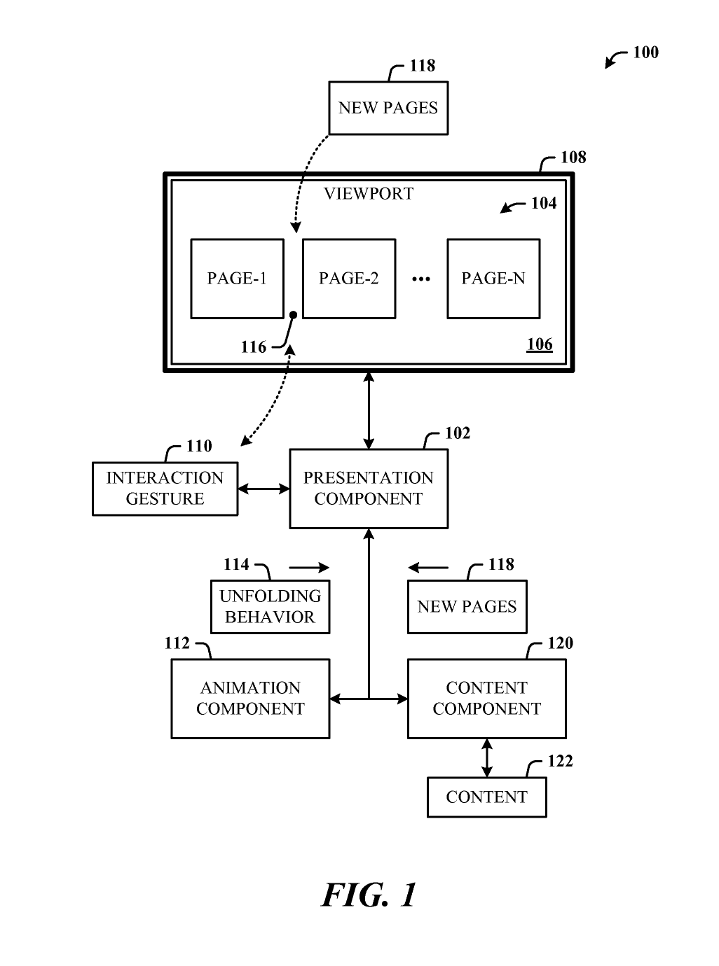

FIG. 1 illustrates a system 100 in accordance with the disclosed architecture. The system 100 can include a presentation component 102 that presents one or more pages 104 of content in a viewport 106 of display 108, and detects an interaction gesture 110 relative to the one or more pages 104 presented in the viewport 106. The interaction gesture 110 can be made via a standard input device such as a mouse, via touch-sensitive displays, and/or via gestures that include non-contact techniques as described herein below. (The dotted arrow indicates the interaction gesture 110 is via a recognition system and/or touch-sensitive input.)

An animation component 112 animates an unfolding behavior 114 at an unfolding location 116 (invisible to the user) relative to the one or more pages 104 in the viewport 106 to expose new pages 118. The unfolding behavior 114 is enabled in any one of multiple directions, in response to the interaction gesture 110. The gesture can indicate the unfolding and new page insertion/unfolding is to occur across a single page of content or between two pages of content, for example.

A content component 120 receives and processes content 122 for presentation in accordance with the unfolding behavior 114. The content 122 can be obtained from data sources such as websites, applications, databases, social networks, etc., and can be any type of media, such as images, text, audio, video, etc., and any combination thereof, such as an image and text, image and audio, etc. The content component 120 formats the content 122 for presentation as unfolding content, to provide content perspective to a point in infinity, for example. The content can be formatted as pages for page handling to enable the unfolding behavior 114.

The interaction gesture 110 indicates the unfolding location such as between two pages (e.g., Page-1 and Page-2) of the one or more pages 104, and the animation component 112 animates the unfolding behavior 114 of the new pages 118 between the two pages (e.g., Page-1 and Page-2), as one example. The interaction gesture 110 indicates the unfolding location in a page (e.g., within the edges that define the Page-2) of the one or more pages 104 and the animation component 112 animates the unfolding behavior 114 of the new pages 118 in the page (e.g., Page-2). Alternatively, the location of the unfolding behavior can be predetermined as the center of a page or piece of content selected via the interaction gesture.

The unfolding behavior 114 is performed relative to a fold axis (the point of visual pivot or connection) of the new pages 118. The unfolding behavior 114 is animated based on the fold axis appearing forward in the viewport 106 or visually perceived as away (distant) from the viewport 106. The multiple directions include vertically, horizontally, and diagonally, and the multiple directions are enabled between pages (e.g., Page-1 and Page-2) of the one or more pages 104 or in a page (e.g., Page-1) of the one or more pages 104.

The unfolding behavior 114 is animated to expose a new page (e.g., of the new pages 118) in visual abutment to two (e.g., Page-1 and Page-2) of the one or more pages 104. That is, a single new page has an edge (of four total edges as in a physical page) that is presented as abutting (touching) an edge of one of the pages 104 being moved aside (displaced) to allow the insertion and unfolding of the new pages 118. A new page can be unfolded to visually abut a single existing page or multiple existing pages. The unfolding behavior 114 partially or entirely displaces at least one page of the one or more pages 104 in the viewport 106 with the new pages 118.

The interaction gesture 110 detected herein is broadly defined to include, but is not limited to, commonly-known and used computer/device input techniques related to, for example, a keyboard, a keypad, a mouse, stylus pen, touch-sensitive displays, and non-contact techniques such as air-gestures using hands, body movements and poses, body appendage poses, hand and/or finger poses, and the like. This further includes recognition systems such as face recognition, facial pose recognition, voice recognition, speech recognition, audio signal recognition, image recognition, text recognition, and so on.

This further includes natural user interface (NUI) inputs. NUI may be defined as any interface technology that enables a user to interact with a device in a “natural” manner, free from artificial constraints imposed by input devices such as mice, keyboards, remote controls, and the like. Examples of NUI methods include those methods that employ gestures, which are broadly defined herein to include, but not limited to, speech recognition, touch and stylus recognition, both on screen and adjacent to the screen, air gestures, head and eye tracking, voice and speech utterances, vision, touch, and machine intelligence.

NUI technologies include, but are not limited to, touch sensitive displays, voice and speech recognition, intention and goal understanding, motion gesture detection using depth cameras (e.g., stereoscopic camera systems, infrared camera systems, color camera systems, and combinations thereof), motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (e.g., electro-encephalograph (EEG)) and other neuro-biofeedback methods. The interaction gesture 110 may also include any combination of the above, such as touch plus a voice command, hand movement and a speech command, etc.

As described herein, the disclosed architecture applies to any device on which it is employed, whether small handheld devices such as smartphones, music players (e.g., CD audio/DVD video covers can be folded/unfolded), e-book readers, tablets, portable computers, desktop computers, vehicle navigation devices—essentially any device/system that includes a display and facilitates user interaction.

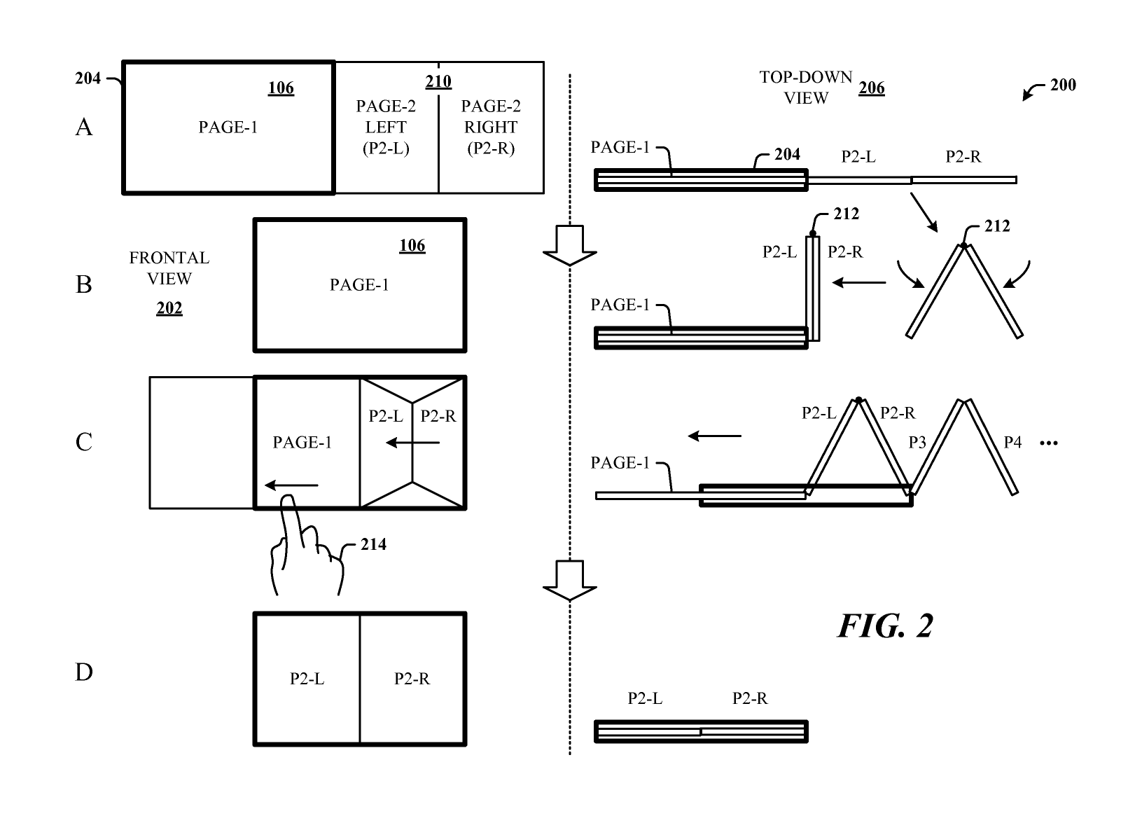

FIG. 2 illustrates a diagram 200 of right-to-left motion and animation for a user experience in accordance with the disclosed architecture. The following description is in the context of using a touch-sensitive display, one or more fingers of a user hand, and both hands. However, as described above, this is not to be construed as so limiting, given the other input techniques that can be employed as interaction gestures.

Here, the animation makes the fold (fold axis) of the new pages (or new content) appear away from the display 108 or user (a rear fold). The diagram 200 is separated into two views for this description: a frontal view 202 that represents how the user may see and interact with the touch-sensitive display 204 to engage the fold animation architecture, and a top-down view 206 that represents how the pages may be virtually and programmatically perceived to be handled as a result of the user interaction; however, it is to be understood that the top-down view 202, top-down view 206, and any out-of-view items/renderings are occurring only in code.

At the top, stage A, of the frontal view 202, the display 204 shows a first page (Page-1), in the display 204 and viewable by the user. A second page 210 (Page-2), is out-of-view to the right of the display 204, and segmented into elements, for example, two elements—a left element (P2-L) of the second page 210, and a right element (P2-R) of the second page 210. In other words, initially, the single full page (Page-1) is configured and rendered in the viewport 106. The following page, second page 210, is segmented (e.g., split into two elements: P2-L and P2-R), and these elements are positioned out-of-view (outside of the viewport 106—the viewing area of display 204) and to the right of the first page (and hence, are not visible to the user). This is also represented in the top-down view 206 where the first page Page-1 is shown in the display 204 while the elements (P2-L and P2-R) of the second page 210, are shown to the right of the display 204.

In a stage B (and also as depicted in the top-down view 206), each of the new elements (P2-L and P2-R) of the second page 210 are then rotated ninety degrees and in opposing directions, in 3D (three-dimensional) space, using 3D transforms such as cascading style sheets (CSS) so that the elements are pointing directly at the user (in 3D). The elements are unfolded along a fold axis 212 such that the fold axis 212 is visually presented as away from the viewer (and the display 204). Element P2-L is set, using CSS, to rotate from its right edge on the fold axis 212, and element P2-R is set to rotate from its left edge on the fold axis 212; and element P2-L is set, using CSS, to rotate from its left edge in abutment with the right edge of the first page, and element P2-R is set to rotate from its right edge in abutment with the right edge of the viewport 106. In this example, the rotated elements (P2-L and P2-R) are positioned on the right edge of the viewport 106. Thus, the viewer sees the first page, Page-1, as in the frontal view 202 of stage B, but not the elements (P2-L and P2-R) of the new page to be unfolded into view.

In stage B, it can be seen that only the elements (P2-L and P2-R) of the new page (Page-2) share the fold axis 212. The first page does not hinge on or attach to the fold axis 212. This is different than conventional virtual books that emulate physical books where all pages hinge on the binding, and page turning is across the binding.

It is to be understood that although only a single fold axis 212 is shown, it is within contemplation of the disclosed architecture that the unfolding behavior with result in more than two pages or pieces of content being exposed using multiple folding axes as is deemed suitable. Moreover, a gesture can be used to further divide the P2-L page to unfold additional content, thus providing “drill-down” effect on existing or new pages/content. Additionally, in stages B and C, it can be seen that as the unfolding behavior executes, the fold axis 212 moves closer to the viewport and leftward until the new pages (P2-L and P2-R) appear flat against the viewport. This kind of 3D effect is provided for rear fold and front fold animations. It can also be implemented to unfold only a single page or one piece of content as can be hinged on one edge of an existing page being displayed, and then rotated into view.

The disclosed architecture also facilitates realtime (processed in the timespan that the actual event is occurring) insertion of content into an unfolded page from feeds of data or other sources that provide such content, for example. Thus, a successive folding-and-unfolding behavior can result in new content being exposed that was not viewed in the immediately previous unfolding behavior.

At stage C, when the user moves the position (drags) of the first page (Page-1) to the left (as represented by a right hand 214 of the user touching the front of the display 204 and dragging the index finger to the left), the right edge of the first page (Page-1) is tracked using a scripting language (e.g., JavaScript™). This is represented in the frontal view 202 as the first page (Page-1) partially exposed in the viewport 106 and the remaining part of the first page (Page-1) as moving leftward out of the viewport 106. The left edge of the left element P2-L of the second page 210 is “pinned” programmatically to the right edge of the first page (Page-1) and the right edge of the first page (Page-1) is used to set the position of the left edge of P2-L and the right edge of P2-R is fixed to the right edge of the viewport 106.

Using JavaScript, the total width of the viewport 106 is computed and divided by ninety; since this 3D animation rotates the object (page(s)) a total of ninety degrees of movement (referred to as the rotation factor). Then, for each pixel of movement, the elements, P2-L and P2-R, of the second page 210 are rotated by the amount of the rotation factor. This is represented in the frontal view 202 and top-down view 206 of stage C, on the right side of the display 204, where second page 210 elements (P2-L and P2-R) appear to be unfolding into view as the first page (Page-1) is being moved to the left by the user finger.

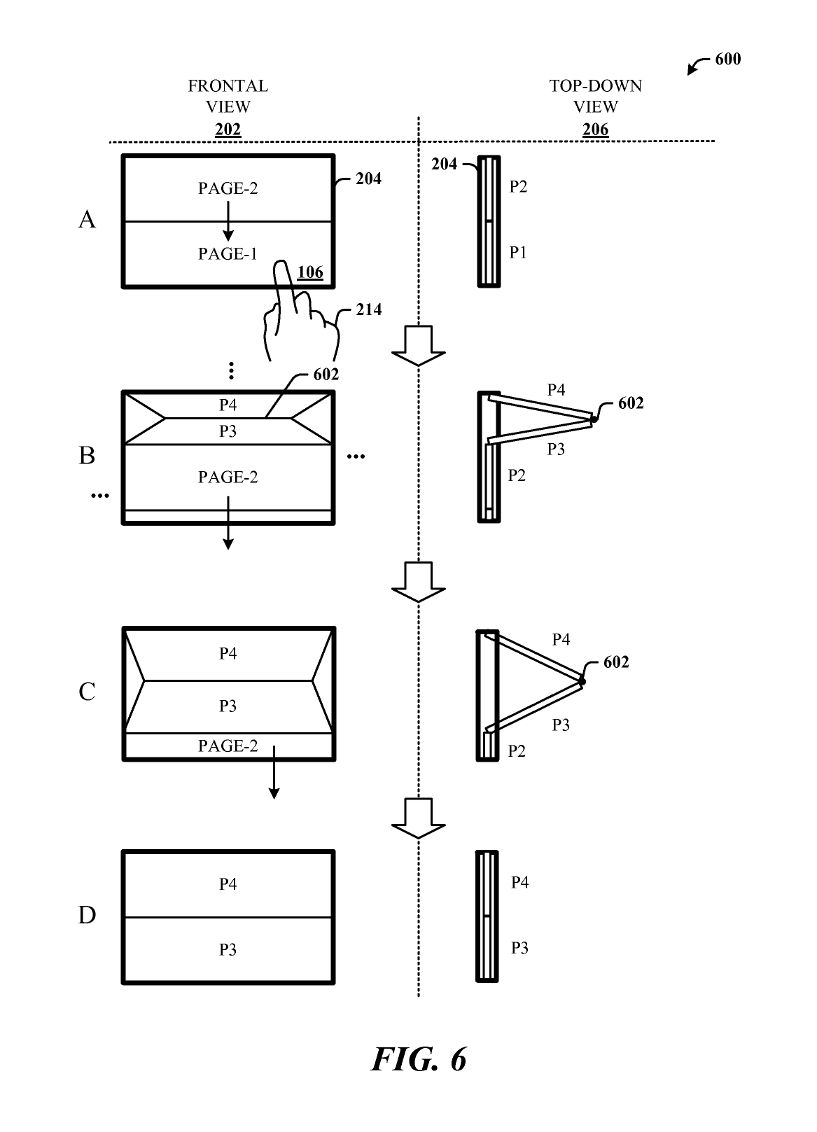

It is to be understood that in some or all cases of document movement into or out of view depicted in describing the disclosed architecture, that although many instances are depicted as only having a single page, or two pages being brought into view, such as for unfolding, there can be additional pages out of view stitched to the page or pages being exposed (unfolding into view or folding out of view) into the viewport; however, for brevity, this is not shown in some or all instances. Thus, in stage C, the top-down view 206, for example, in addition to the second page Page-2 (P2-L and P2-R) unfolding into view, there can be additional pages out of view, such as two pages—Page-3 (P3) and Page-4 (P4)—with Page-3 programmatically stitched to P2-R, and which one or both pages can be dragged into the viewport once P2-L and P2-R are moved leftward. There is no limit on the number of pages that can be prepared and stitched onto page edges in anticipation of user interaction to bring one or more pages into view. This applies as well to the top and bottom edges, diagonals, etc., of any of the pages (e.g., Page-1, P2-L, P2-R, Page-3, Page-4, etc.), as indicated in part, in FIG. 6, with stage B, the frontal view (using the ellipsis “ . . . ”).

Therefore, in addition to Page-3 and Page-4, the can be many additional pages to the right of Page-4, and programmatically stitched and prepared for potential viewing in the viewport 106. It is also possible that the pages/content are enabled to be brought into the viewport 106 in a folded manner so that the user can then be selective as to which fold/page(s)/content to unfold, while other pages/content remain folded in view. An indication of additional pages/content that can be viewed can be to show a fold (axis) in the viewport 106, such as on the edge of the viewport 106. The user is then noticed of the additional pages/content. If there is no fold, there are no additional pages/content.

It is also within contemplation of the disclosed architecture that where the fold is toward the user, a short textual or graphical summary or annotation can be provided on the exposed “binding” of a page so the user can perceive what the content may be on the page prior to unfolding it.

In stage D, by the time the user has fully moved the first page (Page-1) to the left out of the viewport 106, the second page 210 elements (P2-L and P2-R) are rotated (into view) a full ninety degrees to appear flat (against the display viewing area), and will take up the entire viewport 106 of the display 204. This is represented in the frontal view 202 and top-down view 206 of stage D, where the first page (Page-1) is no longer in view. Note that the fold axis 212 can be shown in the display 204 as a virtual demarcation of the two second page elements (P2-L and P2-R), or not shown at all. Note also that a diminishing perspective (e.g., to a point of infinity, as employed in images or paintings) of the unfolding pages (elements P2-L and P2-R) is applied here since the rear fold is farther (away) from the viewer.

In one implementation, the UI presents visible “hotspots” (user interactable areas that are specifically marked for possible user interaction) where the user can interact to cause the unfolding animation to commence. These hotspots can be made to automatically appear based on predetermined configurations related to formatted and prepared pages and/or content (e.g., using PDF (portable document format), image formats, etc.). The hotspots can also be controlled based on the user gesture, so that the user experience is not negatively impacted by the hotspots appearing each time pagination (page navigation by moving pages into and out of the viewport) stops.

The pages and/or content unfolded can be obtained from local user applications such as spreadsheets, word processors, presentation applications, video applications, remote applications, cloud-based sources, user devices, such as smartphones, portable computers, and so on.

When employed with an operating system, for example, the unfolding behavior can be utilized to expose additional desktop icons and content with each successive “slide” motion across the desktop.

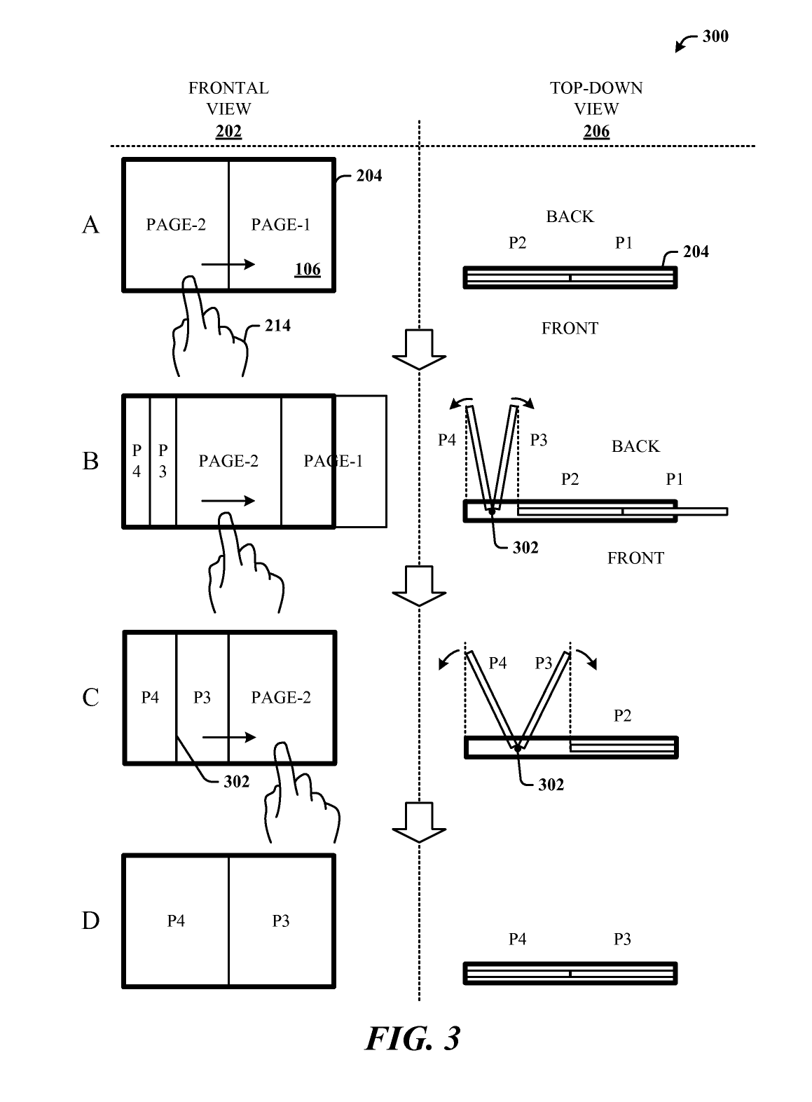

FIG. 3 illustrates a diagram 300 of left-to-right motion and frontward fold axis animation for a user experience in accordance with the disclosed architecture. Here, the animation makes the fold axis appear forward on the display 204 or toward the user (a front fold axis). The diagram 300 is separated into two views for this description: the frontal view 202 that represents how the user may see and interact with the touch-sensitive display 204 to engage the fold animation architecture, and the top-down view 206 that represents how the pages may be virtually and programmatically perceived to be handled as a result of the user interaction; however, it is to be understood that the top-down view 202, top-down view 206, and any out-of-view items/renderings are occurring only in code.

At the top, stage A, of the frontal view 202, the display 204 shows two pages viewable in the viewport: a first page, Page-1, and a second page, Page-2. This is also represented in the top-down view 206 where the first page P1 (also denoted as Page-1 in the frontal view 202) and the second page P2 (also denoted as Page-2 in the frontal view 202) are shown in the display 204. As shown in the frontal view 202, the user hand 214 is interacting with the second page (Page-2) in the display 204 in a touch-and-drag motion to the right. Although not shown, additional new third and fourth pages (P3 and P4) can be prepared as background processing by the content component and positioned on the left side of the viewport 106 for eventual unfolding into the viewport 106 (viewing area) of the display 204.

In a stage B (and also as depicted in the top-down view 206), as the user continues to drag the second page (Page-2) to the right, the first page (Page-1) is pushed out of view, and the additional new pages P3 and P4 begin to come into view on the left side of the viewport 106. Using similar edge pinning/alignment and rotation factor described above, the third and fourth pages are prepared out-of-view as folded along a fold axis 302 such that the fold axis 302 appears up front (toward) the viewer (and the display 204).

At stage C, the first page (Page-1) is now pushed to the right entirely out of the viewport 106, and the third and fourth pages continue to be “pulled” to the right to unfold and expose even more content of the pages (P3 and P4). In stage D, ultimately, the second page (Page-2) is moved entirely from view, and the third and fourth pages (P3 and P4) are entirely in view (rotated a full ninety degrees to appear flat). This is represented in the frontal view 202 and top-down view 206 of stage D. Note that the fold axis 302 can be shown in the display 204 as a virtual demarcation of the two new pages (P3 and P4), or not shown at all. Note also that the diminishing perspective (e.g., to a point of infinity, as employed in images or paintings) of the unfolding pages is not applied here since the fold is nearest to the viewer (or the front of the display 204).

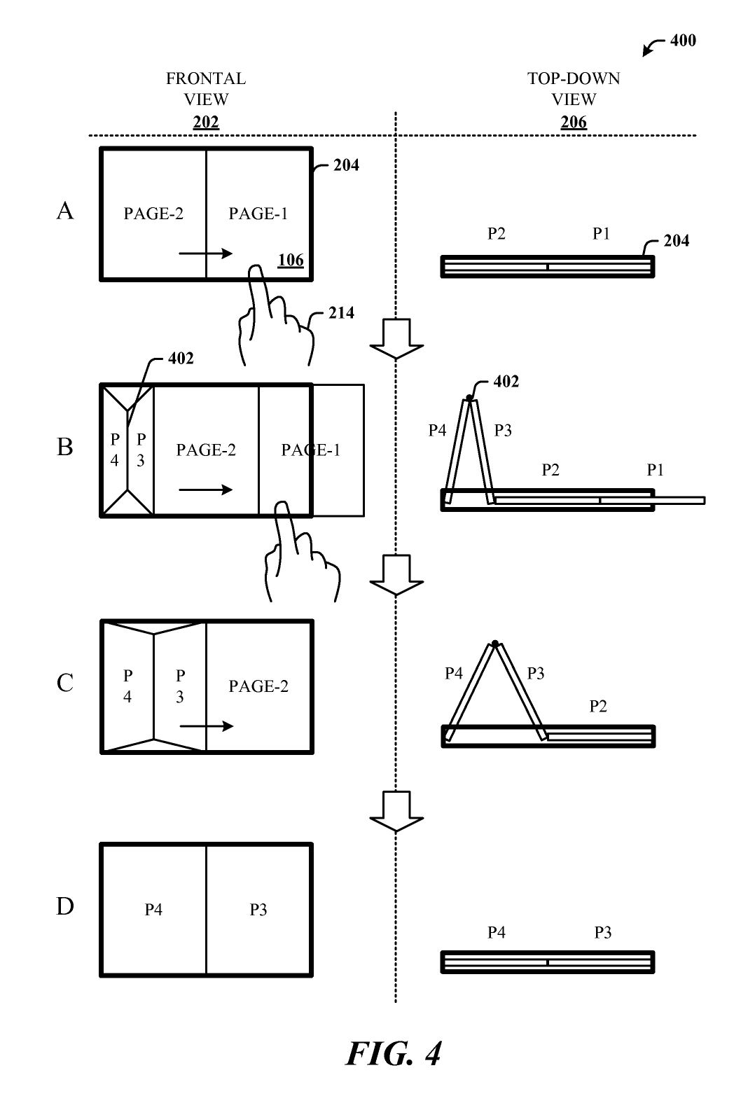

FIG. 4 illustrates a diagram 400 of left-to-right motion and rear fold animation for a user experience in accordance with the disclosed architecture. Here, the fold animation makes the fold axis appear away from the display or the user (a rear fold). The diagram 400 is separated into two views for this description: the frontal view 202 that represents how the user may see and interact with the touch-sensitive display 204 to engage the fold animation architecture, and the top-down view 206 that represents how the pages may be virtually and programmatically perceived to be handled as a result of the user interaction; however, it is to be understood that the top-down view 202, top-down view 206, and any out-of-view items/renderings are occurring only in code.

In stage A, of the frontal view 202, the display 204 shows two pages viewable in the viewport: a first page, Page-1 (also denoted as P1 in the top-down view 206), and a second page, Page-2 (also denoted as P2 in the top-down view 206). This is also represented in the top-down view 206 where the first page P1 (also denoted as Page-1 in the frontal view 202) and the second page P2 (also denoted as Page-2 in the frontal view 202) are shown in the display 204. As shown in the frontal view 202, the user hand 214 is interacting with first page (Page-1) in the display 204 in a touch-and-drag motion to the right. Although not shown, additional new pages, third and fourth pages (P3 and P4), can be prepared as background processing by the content component and positioned on the left side of the viewport 106 for eventual unfolding into the viewport 106 (viewing area) of the display 204.

In a stage B (and also as depicted in the top-down view 206), as the user continues to drag the first page (Page-1) to the right, the first page (Page-1) is dragged out of view, and the new third and fourth pages (P3 and P4) begin to come into view on the left, as the second page (Page-2) is moved (“pulled”) to the right. Using similar edge pinning/alignment and rotation factor described above, the new third and fourth pages are prepared out-of-view as folded along a fold axis 402 such that the fold axis 402 appears away from the viewer (and the display 204) and the unfolding new pages are handled to show perspective from the front to the rear to eventually meet at the fold axis 402.

At stage C, the first page (Page-1) is now entirely out of the viewport 106, the second page (Page-2) is in full view on the right side of the viewport 106, and the new third and fourth pages (P3 and P4) continue to be “pulled” to the right to unfold and expose even more page content. In stage D, ultimately, the second page (Page-2) is moved entirely from view, and the new third and fourth pages (P3 and P4) are entirely in view (rotated a full ninety degrees to appear flat). This is represented in the frontal view 202 and top-down view 206 of stage D. Note that the fold axis 402 can be shown in the display 204 as a virtual demarcation of the two new pages (P3 and P4), or not shown at all. Note also that the diminishing perspective (e.g., to a point of infinity, as employed in images or paintings) of the unfolding new pages for the rear fold axis 402 is applied here, since the fold axis 402 is away from the viewer (or the front of the display 204).

Animation, as described herein can include many different effects, such as an inertia effect on a page moving out of the viewport 106 such that the user hand 214 (a finger of) need not maintain contact with the touch-sensitive surface of the display 204 to drag or push, but can interact momentarily with the display surface as a brief straight line motion, a “flick” motion, of a finger that applies inertia to the page sufficient to move the page a predetermined distance. It can be the case that the inertia is sufficient to “snap” the page to a predefined position. For example, the user can flick the second page (Page-2) to the right, and in response, once the right edge of the second page (Page-2) aligns to the right edge of the viewport 106, the second page (Page-2) stops, until the user, again, interacts to move the second page (Page-2).

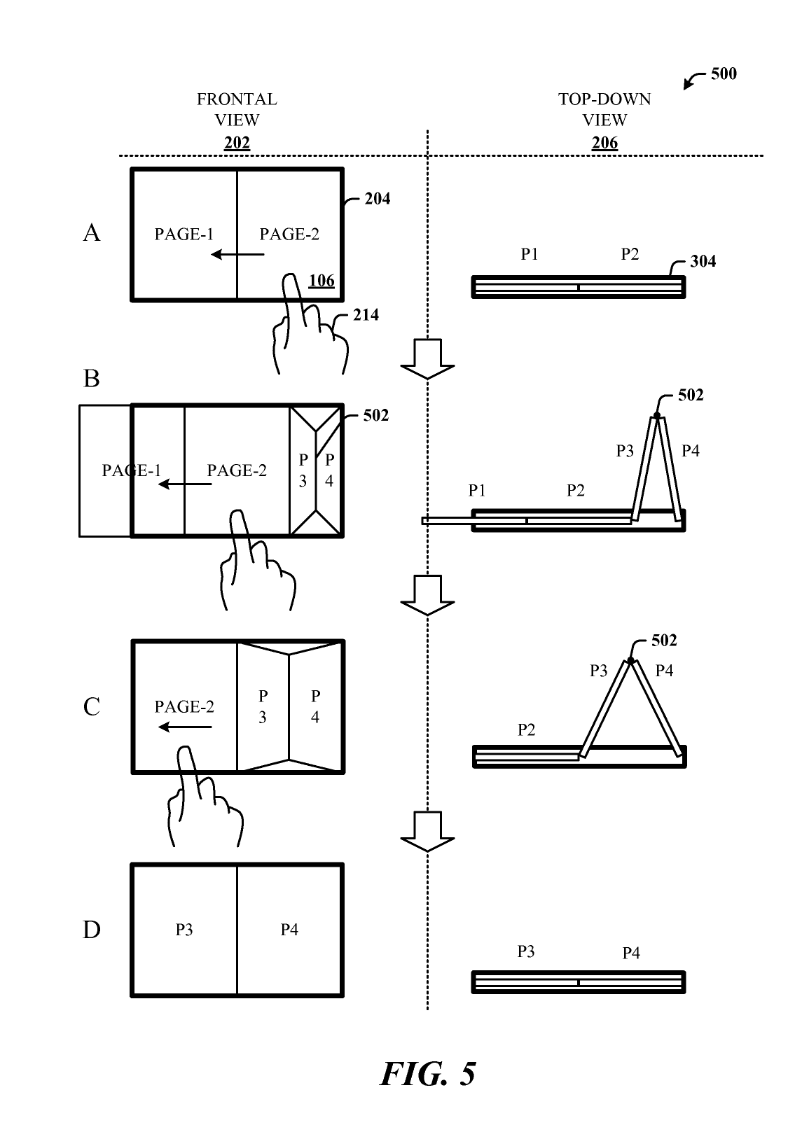

FIG. 5 illustrates a diagram 500 of right-to-left motion and rear fold axis animation for a user experience in accordance with the disclosed architecture. Here, again, the animation makes the fold axis appear away from the display 204 or the user (a rear fold). The diagram 500 is separated into two views for this description: the frontal view 202 that represents how the user may see and interact with the touch-sensitive display 204 to engage the fold animation architecture, and the top-down view 206 that represents how the pages may be virtually and programmatically perceived to be handled as a result of the user interaction; however, it is to be understood that the top-down view 202, top-down view 206, and any out-of-view items/renderings are occurring only in code.

At the top, stage A, of the frontal view 202, the display 204 shows two pages viewable in the viewport: a first page, Page-1, and a second page, Page-2. This is also represented in the top-down view 206 where the first page P1 (also denoted as Page-1 in the frontal view 202) and the second page P2 (also denoted as Page-2 in the frontal view 202) are shown in the display 204. As shown in the frontal view 202, the user hand 214 is interacting with second page (Page-2) in the display 204 in a touch-and-drag motion to the left. Although not shown, additional new third and fourth pages (P3 and P4) can be prepared as background processing by the content component and positioned on the right side of the viewport 106 for eventual unfolding into the viewport 106 (viewing area) of the display 204.

In a stage B (and also as depicted in the top-down view 206), as the user continues to drag the first page (Page-1) to the left, the first page (Page-1) is dragged out of view, and the new third and fourth pages (P3 and P4) begin to come into view on the right of the viewport 106, as the second page (Page-2) is moved (e.g., “pulled”) to the left. Using similar edge pinning/alignment and rotation factor described above, the new third and fourth pages are prepared out-of-view as folded along a fold axis 502 such that the fold axis 502 appears away from the viewer (and the display 204) and the new unfolding pages are handled to show perspective from the front to the rear to eventually meet at the fold axis 502.

At stage C, the first page (Page-1) is now entirely out of the viewport 106, the second page (Page-2) is in full view on the left side of the viewport 106, and the new third and fourth pages (P3 and P4) continue to be “pulled” to the left to unfold and expose even more new page content. In stage D, ultimately, the second page (Page-2) is moved entirely from view, and the new third and fourth pages (P3 and P4) are entirely in view (rotated a full ninety degrees to appear flat). This is represented in the frontal view 202 and top-down view 206 of stage D. Note that the fold axis 502 can be shown in the display 204 as a virtual demarcation of the two new pages (P3 and P4), or not shown at all. Note also that the diminishing perspective (e.g., to a point of infinity, as employed in images or paintings) of the unfolding new pages for the rear fold is applied here since the fold axis 502 is away from the viewer (or away from the front of the display 204).

As previously described, animation disclosed herein can include an inertia effect of a page moving out of the viewport 106 such that the user hand 214 (finger) need not maintain contact with the touch-sensitive surface of the display 204 to drag or push, but can interact momentarily with the display surface as a brief directional motion, a “flick” motion, of a finger that applies inertia to the page to move a predetermined distance. It can be the case that the inertia is sufficient to move the page to a “snap” position such that a snap operation pulls the page to a predefined position. For example, at stage B, the user can flick the second page (Page-2) to the left, and in response, once the left edge of the second page (Page-1) aligns to the left edge of the viewport 106, the second page (Page-2) stops, until the user, again, interacts to move the second page (Page-2).

FIG. 6 illustrates a diagram 600 of top-to-bottom motion and rear fold axis animation for a user experience in accordance with the disclosed architecture. Here, again, the fold animation makes the fold axis appear away from the display 204 or the user (a rear fold). The diagram 600 is separated into two views for this description: the frontal view 202 that represents how the user may see and interact with the touch-sensitive display 204 to engage the fold animation architecture, and the top-down view 206 that represents how the pages may be virtually and programmatically perceived to be handled as a result of the user interaction; however, it is to be understood that the top-down view 202, top-down view 206, and any out-of-view items/renderings are occurring only in code.

In stage A, of the frontal view 202, the display 204 shows two pages viewable in the viewport: a first page, Page-1 (also denoted as P1 in the top-down view 206), and a second page, Page-2 (also denoted as P2 in the top-down view 206), above the first page. As shown in the frontal view 202, the user hand 214 is interacting with first page (Page-1) in the display 204 in a touch-and-drag motion downward. Although not shown, additional new third and fourth pages (P3 and P4) can be prepared as background processing by the content component and positioned on the top edge of the viewport 106 for eventual unfolding into the viewport 106 (viewing area) of the display 204.

In a stage B (and also as depicted in the top-down view 206), as the user continues to drag the first page (Page-1) downward, the first page (Page-1) is dragged out of view, and the new third and fourth pages (P3 and P4) begin to come into view on the top of the viewport 106, as the second page (Page-2) is moved (“pulled”) downward. Using similar edge pinning/alignment and rotation factor described above, the new third and fourth pages are prepared out-of-view as folded along a fold axis 602 such that the fold axis 602 appears away from the viewer (and the display 204) and the new unfolding pages are handled to show perspective from the front to the rear to eventually meet at the fold axis 602.

At stage C, the first page (Page-1) is now entirely out of the viewport 106, the second page (Page-2) is in partial view on the bottom of the viewport 106, and the new third and fourth pages (P3 and P4) continue to unfold downward and expose even more page content. In stage D, ultimately, the second page (Page-2) is moved entirely from view, and the new third and fourth pages (P3 and P4) are entirely in view (rotated a full ninety degrees to appear flat). This is represented in the frontal view 202 and top-down view 206 of stage D. Note that the fold axis 602 can be shown in the display 204 as a virtual demarcation of the two new pages (P3 and P4), or not shown at all. Note also that the diminishing perspective (e.g., to a point of infinity, as employed in images or paintings) of the unfolding pages for the rear fold is applied here since the fold axis is away from the viewer (or away from the front of the display 204).

Note that in this landscape display example, the current and new pages (Page-1, Page-2, P1, and P2) are sized accordingly to fill the viewport 106 of the display 204; however, this is not a requirement, in that the page(s) can be sized accordingly to maintain proportions rather than introducing dimensional distortions in either of the axes of the viewport 106.

As previously described, animation disclosed herein can include an inertia effect of a page moving out of the viewport 106 such that the user hand 214 (finger) need not maintain contact with the touch-sensitive surface of the display 204 to drag or push, but can interact momentarily with the display surface as a brief directional motion, a “flick” motion, of a finger that applies an inertia effect to the page (e.g., Page-2) to move a predetermined distance.

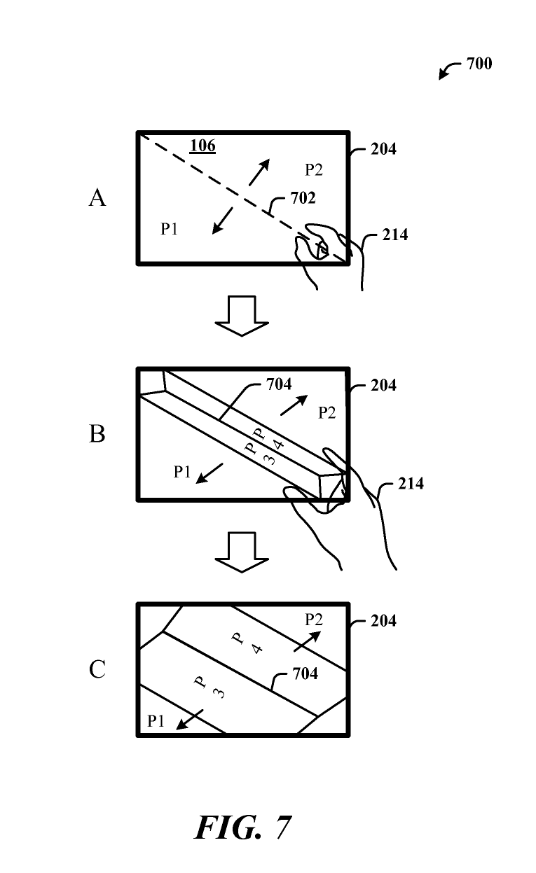

FIG. 7 illustrates a diagram 700 of diagonal and rear unfolding animation for a user experience in accordance with the disclosed architecture. Here, again, the fold animation makes the fold axis appear away from the display or the user (a rear fold).

In stage A, the display 204 shows two pages viewable in the viewport 106 interfaced or abutted along a diagonal 702: a first page (P1) and a second page (P2) above the first page (P1). As shown in the frontal view, the user hand 214 is interacting proximate the diagonal 702 of the two pages (P1 and P2) in the display 204 in a touch-and-split (spread or separate) finger motion to spread apart the two pages (P1 and P2) at the diagonal 702, using two fingers of the hand 214 that initially set the touch points on either side of the diagonal 702, and thereafter, spread to indicate separation of the diagonal 702 to enable unfolding of new pages. Although not shown at this stage, additional third and fourth pages (P3 and P4) can be prepared in association with the diagonal 702 for eventual unfolding at the diagonal 702 into the viewport 106 (viewing area) of the display 204.

In a stage B, and as depicted, as the user spreads two fingers apart of the hand 214, while in contact with the touch-sensitive display surface, the first page P1 and the second page P2 are both push aside (e.g., displaced in opposite directions) to enable unfolding and increased viewing of the new third and fourth pages (P3 and P4). Using similar edge pinning/alignment and rotation factor described above, the new third and fourth pages (P3 and P4) are prepared out-of-view as folded along a fold axis 704 such that the fold axis 704 appears away from the viewer (and the display 204) as the new third and fourth pages are unfolded into view. The new unfolding pages are handled to show perspective from the front to the rear to eventually meet at the fold axis 704.

At stage C, the first page P1 and the second page P2 are both pushed (displaced) almost out of sight in the viewport 106 as the unfolding of new pages (P3 and P4) nears completion. Again, the inertia effect can be applied such that once the user spread the fingers the animation system continues pushing the first and second pages (P1 and P2) aside (out of the viewport 106) and unfolding new pages (P3 and P4) until fully opened (exposed all content in the viewport 106).

Another animation effect can be obtained by anchoring (maintaining touch contact with the display surface) one finger while moving the other finger so as to cause unfolding away from the anchored finger. Moreover, this two-finger spreading can be accomplished using a single finger on each hand.

As before, the new third and fourth pages (P3 and P4) are partially or fully in view (rotated a full ninety degrees to appear flat). Note that the fold axis 704 can be shown in the display 204 as a virtual demarcation of the two pages (P3 and P4), or not shown at all. Note also that the diminishing perspective (e.g., to a point of infinity, as employed in images or paintings) of the unfolding new pages for the rear fold is applied here since the fold axis 704 is away from the viewer (or away from the front of the display 204).

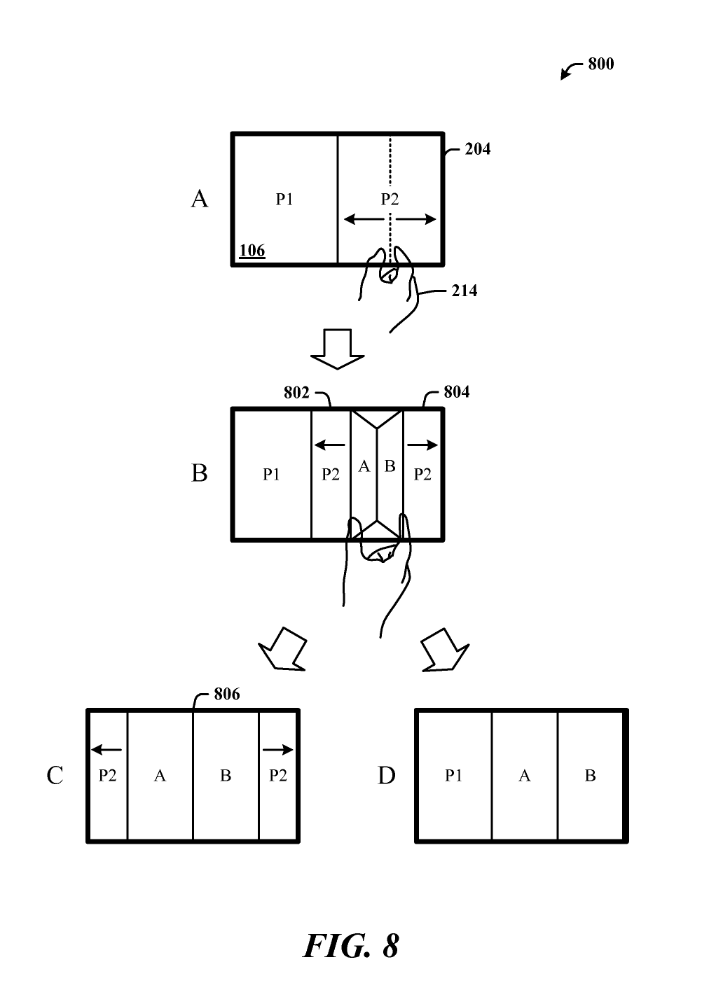

FIG. 8 illustrates a diagram 800 of a vertical split page (or unfold from within another page) and rear fold animation for a user experience in accordance with the disclosed architecture. Here, again, the fold animation performs a rear fold that appears away from the display or the user.

In stage A, of the frontal view, the display 204 shows two pages viewable in the viewport: a first page (P1) and a second page (P2) to the right of the first page. As shown, fingers of the user hand 214 interact within the second page P2 in preparation for a touch-and-split (spread or separate) finger motion to spread apart the second page P2 at the touch point.

In stage B, the two fingers are spread apart while touching the touch-sensitive display 204 to indicate separation of the second page P2 and to enable unfolding of new content (A and B) within the second page. Although not shown at this stage, the additional new content (A and B) can be prepared for possible unfolding into the viewport (viewing area) of the display 204 at a selected touch point. The new content (A and B) can be selected to be related in substance to the content of the second page P2, or may be unrelated.

As the new content (A and B) unfolds, page handling of the first and second pages (P1 and P2) can occur in several ways: in a first way, the first page P1 remains in place, the second page P2 is entirely consumed by the new content (A and B), and hence, removed from viewing. In a second way, a left section 802 of the second page pushes the first page P1 to the left and out of the viewport 106 as the new content (A and B) continues to unfold, and a right section 804 of the second page P2 remains fixed in place along the right edge of the viewport 106. Thus, the final view is as depicted in stage C, where the rear fold axis moves leftward and forward to enable full expansion and exposure of the new content (A and B). Alternatively, at stage D, the second page P2 can be pushed out (replaced with, displaced) of view by the new content (A and B) while the first page P1 retains its original position.

It is to be appreciated that in all fold animation scenarios described herein, the reverse process can be performed. In other words, in Stage C, the user fingers can be placed to straddle the boundary 806 that delineates new content A and new content B, and then perform a pinching motion, in response to which a folding effect of both the new content A and the new content B occurs, folding new content (A and B) out of sight and then replacing this space with the first page P1 or a new page, or replacing this space with the second page P2 or a new page, etc.

Moreover, the type of fold employed, rear or front, can occur in reverse. That is, if a rear fold (fold axis) enabled during unfolding (exposure) of new content, a rear fold can again be used when folding (closing) the new content. Alternatively, a rear fold performed in a first operation that unfolds to expose more content (pages of) can be replaced with a forward fold when reversing the first operation to fold the content from view. In yet another implementation, closing out (folding away from view) one set of content and then immediately unfolding, can be configured to automatically trigger a new set of content to be exposed during the subsequent unfolding process.

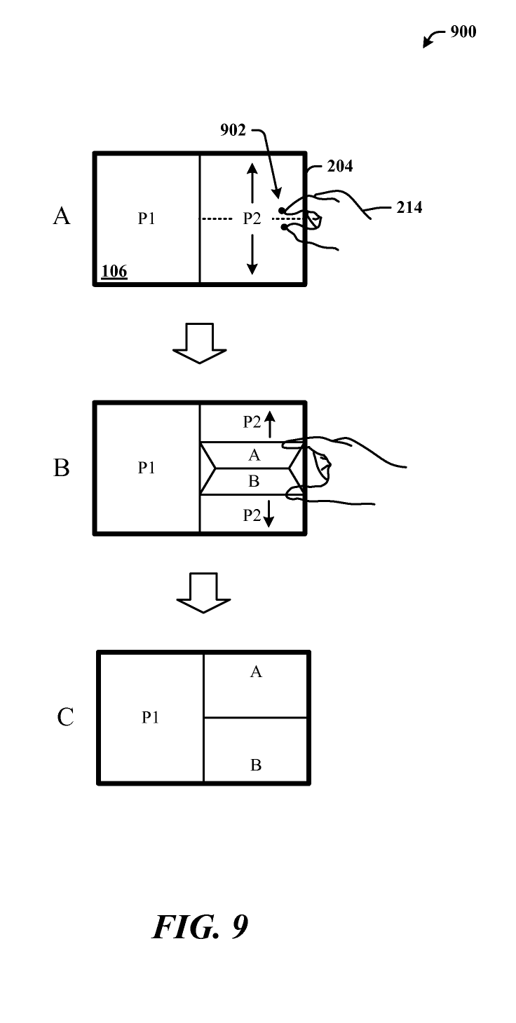

FIG. 9 illustrates a diagram 900 of a horizontal split page (or unfold from within another page) and fold animation of a rear fold for a user experience in accordance with the disclosed architecture. Here, again, the fold animation performs a rear fold that appears away from the display 204 or the user.

In stage A, of the frontal view, the display 204 shows two pages viewable in the viewport 106: a first page (P1), and a second page (P2) to the right of the first page. As shown, fingers of the user hand 214 interact within the second page P2 in a touch-and-split (spread or separate) finger motion to spread apart the second page P2 at touch points 902 (or at the page center). The touch points 902 can indicate that page or content separation is to occur between the two touch points 902, and approximately orthogonal to a line that intersects the two touch points 902 (here, the dotted line across the second page P2).

In stage B, the two fingers are spread apart while touching the touch-sensitive display 204 to indicate separation and to enable unfolding of new content (A and B) within the second page P2. Although not shown at this stage, the new content (A and B) can be prepared for possible unfolding into the viewport 106 (viewing area) of the display 204 at a selected point. The new content (A and B) can be selected to be related to the content (a topic of interest) of the second page P2, or may be unrelated (e.g., an advertisement).

The fold animation effects described herein can also be enabled in this example. As the new content (A and B) unfolds, the first page P1 remains in place, the second page P2 is entirely consumed by the new content (A and B), and hence, removed from viewing, as shown in stage C.

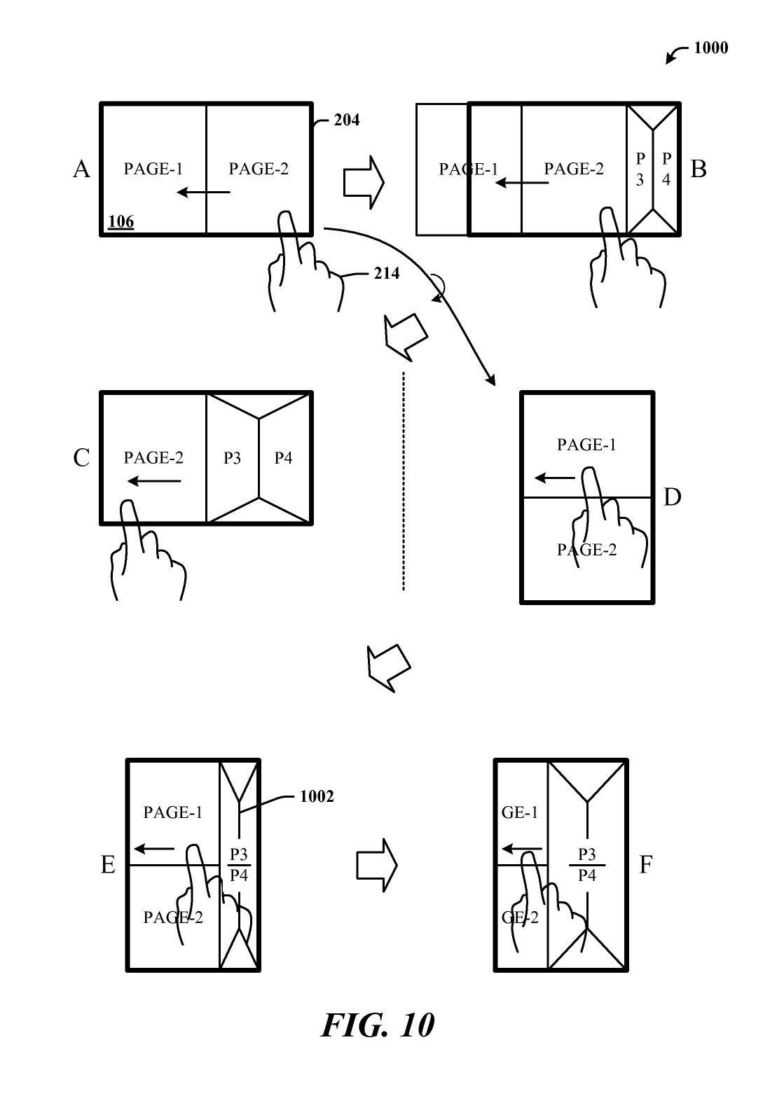

FIG. 10 illustrates a diagram 1000 of fold animation where unfolding occurs along two other pages. At stage A, the display 204 is in a landscape orientation showing a first page Page-1 and a second page Page-2. The index finger of the user hand 214 touches the surface of the display 304 on the second page, and drags (sustained surface contact in a certain direction) to the left to move both the first and second pages leftward. At stage B, the first page is partially from out of view the viewport 106, and a rear fold of two new pages (of content)—a third page P3 and a fourth page P4—come into view from the right edge of the viewport 106. At stage C, the first page (Page-1) is now entirely out of the viewport 106, the second page (Page-2) assumes the position previously held by the first page, while the new third and fourth pages continue to unfold to expose more content.

At stage D, the display 204, as relative to stage A, is now rotated into a portrait orientation. Accordingly, the pages (Page-1, Page-2, P3, and P4) are automatically orientated differently. For example, the first page is now positioned on top of the second page. The user finger is on the first page and moving in a leftward motion. At stage E, the unfolding new pages (P3 and P4) appear as extending the full height of the display 204, and abutting the edges of both the first and second pages. Moreover, the new third page P3 is now positioned above the new fourth page P4 such that the fold axis 1002 runs vertically through both the third and fourth pages, wherein the unfolding process operates to expose (content) portions of both the third and fourth pages on both sides of the rear fold axis 1002. Thus, at stage F, as the user continues to move (or an inertia stroke causes) the first and second pages to move leftward out of view, ultimately (not shown), the new third and fourth pages will be rendered entirely in the display 204, showing the third page on top (or above) the fourth page.

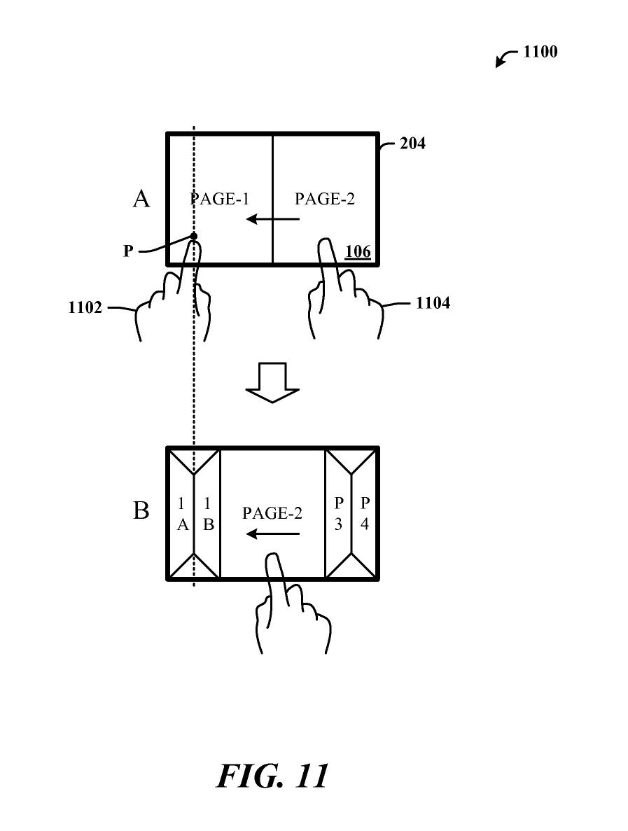

FIG. 11 illustrates a diagram 1100 of fold animation where two hands can be used to indicate folding of one page and unfolding of new pages. Here, the left hand 1102 can be used to create a (touch) point P where the first page (Page-1) folds out of view and the right hand 1104 can indicate which page to move, and the direction of movement (e.g., move Page-2 leftward). In stage A, the left index finger of the left hand 1102 touches the display 204 at point P, and which also defines a vertical line (denoted as dotted) on which the folding operation of the first page can be initiated (in two page parts—1A and 1B). As the right index finger of the right hand 1104 moves the second page leftward, new third and fourth pages (P3 and P4) are beginning to unfold using a rear fold (axis), and the first page begins folding out of view as a single page folded into the 1A half and 1B half. At the user continues moving the second page leftward (or the page moved freely), the second page can also fold out of view at the same point P. Ultimately, the first page and the second page fold out of the viewport 106 and the new third and fourth pages unfold into total view.

It is to be appreciated that the point P can be marked using only one hand, in that once marked, a slight time delay enables the user to then use the same hand to initiate movement of the desired page(s) in the desired direction.

It can also be the case that the disclosed architecture enables the user to arbitrarily define the fold/unfold location(s) and orientation with a single stroke that defines two points. It can also be enabled that the user is allowed to “peek” at the new content (pages) being unfolded (before the content (pages) is entirely unfolded), then to fold up the existing content (pages), and then unfold to a new set of content (pages).

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

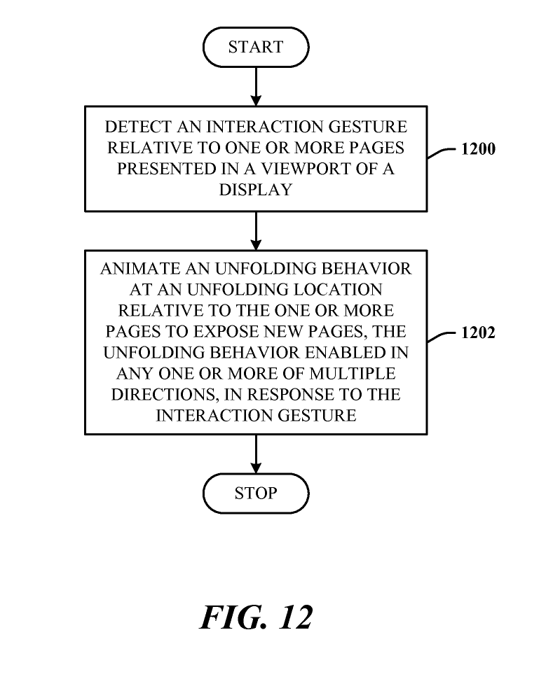

FIG. 12 illustrates a method in accordance with the disclosed architecture. At 1200, an interaction gesture is detected relative to one or more pages presented in a viewport of a display. The gesture is detected as interactively engaging the user interface to cause the fold animation. In one embodiment, the gesture is hand touch on a touch-sensitive display. At 1202, an unfolding behavior is animated at an unfolding location relative to the one or more pages to expose new pages. The location can be determined based on a touch point on the display surface and/or automatically predetermined for a page or piece of content. The unfolding behavior is enabled in any one or more of multiple directions, in response to the interaction gesture. In other words, the gesture can indicate where the unfolding will occur (e.g., in a page or piece of content, between pages or pieces of content, on one edge of the page or piece of content, etc.) and in what direction (e.g., vertically, horizontally, diagonally).

A microprocessor can be configured to execute instructions in a memory, where the instructions associated with at least one of the acts of detecting or animating.

The method can further comprise animating the unfolding behavior by exposing some or all of the new pages concurrently relative to a fold axis. The new pages are exposed at the same time, and not sequentially as in convention page turning. Similarly, the new content is exposed at the same time.

The method can further comprise animating the unfolding behavior as associated with a fold axis that appears forward in the viewport or back in the viewport. The fold defines the fold axis, and thus, the fold axis defines the unfolding animation. The method can further comprise animating the unfolding behavior in one of the one or more pages to expose the new pages, and as visually abutting one of the one or more pages to expose the new pages.

The method can further comprise animating the unfolding behavior in response to the interaction gesture, where the gesture is interpreted as moving one page of the one or more pages away from the unfolding location. Essentially, the user is moving one or more of the pages out of the way so the new pages can be unfolded and presented. The method can further comprise animating the unfolding behavior along a diagonal of the viewport to expose the new pages. The method can further comprise animating the unfolding behavior vertically or horizontally in the viewport to expose the new pages.

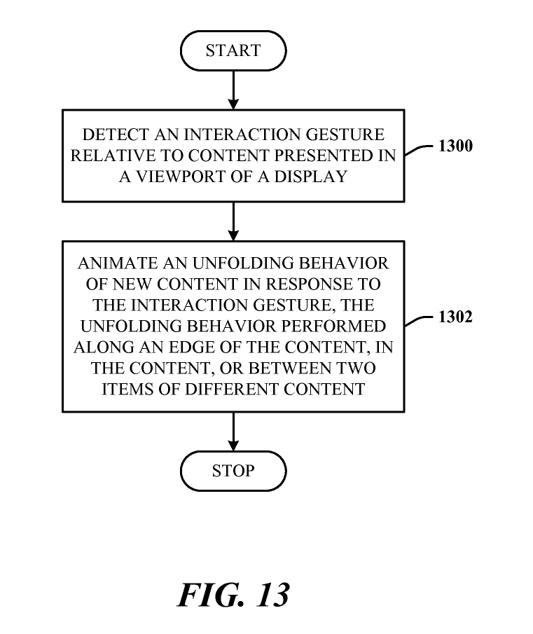

FIG. 13 illustrates an alternative method in accordance with the disclosed architecture. At 1300, an interaction gesture is detected relative to content presented in a viewport of a display. At 1302, an unfolding behavior of new content is animated in response to the interaction gesture. The unfolding behavior is performed along an edge of the content, in the content, or between two items of different content.

The method can further comprise animating the unfolding behavior of the new content along a fold axis that is one of vertical, horizontal, or diagonal, and displacing some or all of the content with the new content based on the interaction gesture. The method can further comprise animating the unfolding behavior to visually perceive the new content as abutting the content on one edge of the content, as abutting the content on two edges, or abutting the two items of content on opposing edges of the two items of content. The method can further comprise animating the unfolding behavior as unfolding toward the viewport or unfolding away from the viewport.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

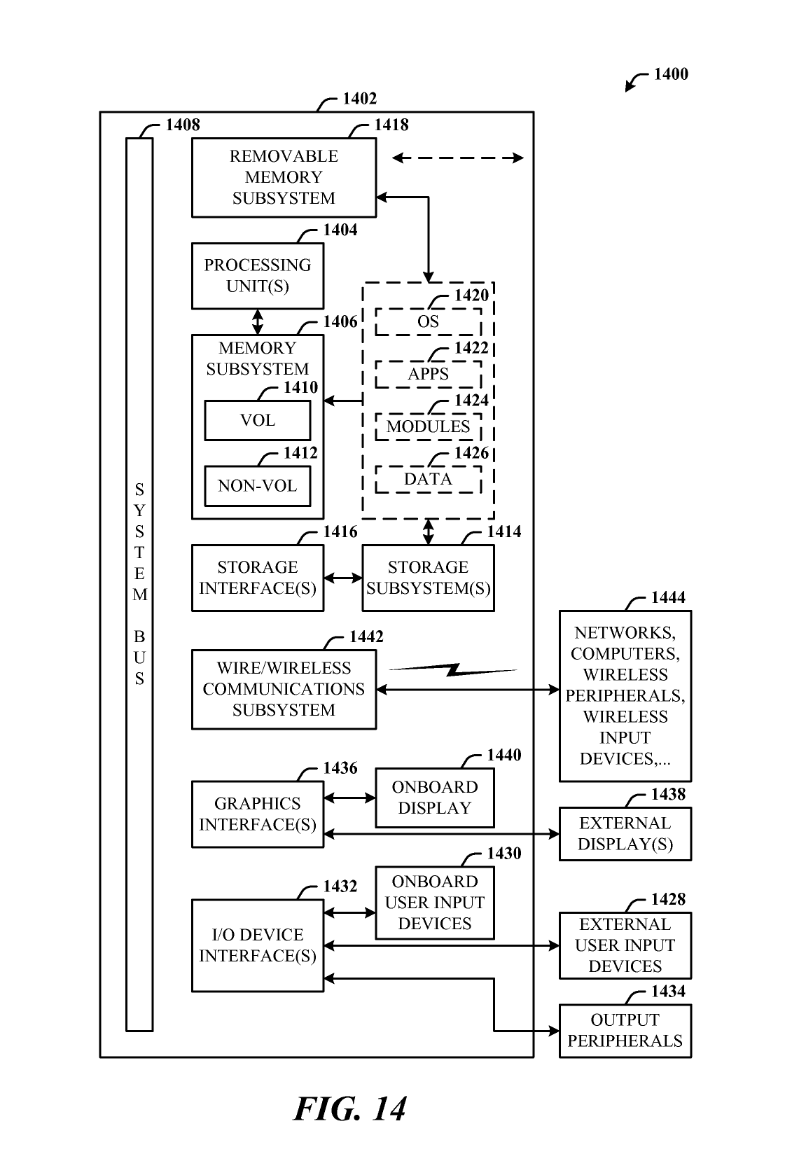

Referring now to FIG. 14, there is illustrated a block diagram of a computing system 1400 that executes animated fold animation in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 14 and the following description are intended to provide a brief, general description of the suitable computing system 1400 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1400 for implementing various aspects includes the computer 1402 having processing unit(s) 1404 (also referred to as microprocessor(s) and processor(s)), a computer-readable storage medium such as a system memory 1406 (computer readable storage medium/media also include magnetic disks, optical disks, solid state drives, external memory systems, and flash memory drives), and a system bus 1408. The processing unit(s) 1404 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 1402 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 1406 can include computer-readable storage (physical storage) medium such as a volatile (VOL) memory 1410 (e.g., random access memory (RAM)) and a non-volatile memory (NON-VOL) 1412 (e.g., ROM, EPROM, EEPROM, etc.). A basic input/output system (BIOS) can be stored in the non-volatile memory 1412, and includes the basic routines that facilitate the communication of data and signals between components within the computer 1402, such as during startup. The volatile memory 1410 can also include a high-speed RAM such as static RAM for caching data.

The system bus 1408 provides an interface for system components including, but not limited to, the system memory 1406 to the processing unit(s) 1404. The system bus 1408 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1402 further includes machine readable storage subsystem(s) 1414 and storage interface(s) 1416 for interfacing the storage subsystem(s) 1414 to the system bus 1408 and other desired computer components. The storage subsystem(s) 1414 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 1416 can include interface technologies such as EIDE, ATA, SATA, and IEEE 1394, for example.

One or more programs and data can be stored in the memory subsystem 1406, a machine readable and removable memory subsystem 1418 (e.g., flash drive form factor technology), and/or the storage subsystem(s) 1414 (e.g., optical, magnetic, solid state), including an operating system 1420, one or more application programs 1422, other program modules 1424, and program data 1426.

The operating system 1420, one or more application programs 1422, other program modules 1424, and/or program data 1426 can include entities and components of the system 100 of FIG. 1, entities and components in the flow of diagram 200 of FIG. 2, entities and components in the flow of diagram 300 of FIG. 3, entities and components in the flow of diagram 400 of FIG. 4, entities and components in the flow of diagram 500 of FIG. 5, entities and components in the flow of diagram 600 of FIG. 6, entities and components in the flow of diagram 700 of FIG. 7, entities and components in the flow of diagram 800 of FIG. 8, entities and components in the flow of diagram 900 of FIG. 9, entities and components in the flow of diagram 1000 of FIG. 10, entities and components in the flow of diagram 1100 of FIG. 11, and the methods represented by the flowcharts of FIGS. 12 and 13, for example.

Generally, programs include routines, methods, data structures, other software components, etc., that perform particular tasks or implement particular abstract data types. All or portions of the operating system 1420, applications 1422, modules 1424, and/or data 1426 can also be cached in memory such as the volatile memory 1410, for example. It is to be appreciated that the disclosed architecture can be implemented with various commercially available operating systems or combinations of operating systems (e.g., as virtual machines).

The storage subsystem(s) 1414 and memory subsystems (1406 and 1418) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 1402, and include volatile and non-volatile internal and/or external media that is removable and/or non-removable. For the computer 1402, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 1402, programs, and data using external user input devices 1428 such as a keyboard and a mouse, as well as by voice commands facilitated by speech recognition. Other external user input devices 1428 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1402, programs, and data using onboard user input devices 1430 such a touchpad, microphone, keyboard, etc., where the computer 1402 is a portable computer, for example.

These and other input devices are connected to the processing unit(s) 1404 through input/output (I/O) device interface(s) 1432 via the system bus 1408, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1432 also facilitate the use of output peripherals 1434 such as printers, audio devices, camera devices, and so on, such as a sound card and/or onboard audio processing capability.

One or more graphics interface(s) 1436 (also commonly referred to as a graphics processing unit (GPU)) provide graphics and video signals between the computer 1402 and external display(s) 1438 (e.g., LCD, plasma) and/or onboard displays 1440 (e.g., for portable computer). The graphics interface(s) 1436 can also be manufactured as part of the computer system board.

The computer 1402 can operate in a networked environment (e.g., IP-based) using logical connections via a wired/wireless communications subsystem 1442 to one or more networks and/or other computers. The other computers can include workstations, servers, routers, personal computers, microprocessor-based entertainment appliances, peer devices or other common network nodes, and typically include many or all of the elements described relative to the computer 1402. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1402 connects to the network via a wired/wireless communication subsystem 1442 (e.g., a network interface adapter, onboard transceiver subsystem, etc.) to communicate with wired/wireless networks, wired/wireless printers, wired/wireless input devices 1444, and so on. The computer 1402 can include a modem or other means for establishing communications over the network. In a networked environment, programs and data relative to the computer 1402 can be stored in the remote memory/storage device, as is associated with a distributed system. It will be appreciated that the network connections shown are exemplary and other means of establishing a communications link between the computers can be used.

The computer 1402 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a presentation component that presents one or more pages of content in a viewport of display, and detects an interaction gesture relative to the one or more pages presented in the viewport;
an animation component that animates an unfolding behavior at an unfolding location relative to the one or more pages in the viewport to expose new pages, the unfolding behavior is enabled in any one of multiple directions, in response to the interaction gesture; and
a microprocessor that executes computer-executable instructions associated with at least one of the presentation component or the animation component.

2. The system of claim 1, wherein the interaction gesture indicates the unfolding location between two pages of the one or more pages and the animation component animates the unfolding behavior of the new pages between the two pages.

3. The system of claim 1, wherein the interaction gesture indicates the unfolding location in a page of the one or more pages and the animation component animates the unfolding behavior of the new pages in the page.

4. The system of claim 1, wherein the unfolding behavior is relative to a fold axis of the new pages, the unfolding behavior animated based on the fold axis appearing forward in the viewport or away from the viewport.

5. The system of claim 1, wherein the multiple directions include vertically, horizontally, and diagonally, and the multiple directions are enabled between pages of the one or more pages or in a page of the one or more pages.

6. The system of claim 1, wherein the unfolding behavior is animated to expose a new page in visual abutment to two of the one or more pages.

7. The system of claim 1, wherein the unfolding behavior partially or entirely displaces at least one page of the one or more pages in the viewport with the new pages.

8. A method performed by a computer system executing machine-readable instructions, the method comprising acts of:
detecting an interaction gesture relative to one or more pages presented in a viewport of a display;
animating an unfolding behavior at an unfolding location relative to the one or more pages to expose new pages, the unfolding behavior enabled in any one or more of multiple directions, in response to the interaction gesture; and
configuring a microprocessor to execute instructions in a memory, the instructions associated with at least one of the acts of detecting or animating.

9. The method of claim 8, further comprising animating the unfolding behavior by exposing some or all of the new pages concurrently relative to a fold axis.

10. The method of claim 8, further comprising animating the unfolding behavior as associated with a fold axis that appears forward in the viewport or back in the viewport.

11. The method of claim 8, further comprising animating the unfolding behavior in one of the one or more pages to expose the new pages.

12. The method of claim 8, further comprising animating the unfolding behavior as visually abutting one of the one or more pages to expose the new pages.

13. The method of claim 8, further comprising animating the unfolding behavior in response to the interaction gesture interpreted as moving one page of the one or more pages away from the unfolding location.

14. The method of claim 8, further comprising animating the unfolding behavior along a diagonal of the viewport to expose the new pages.

15. The method of claim 8, further comprising animating the unfolding behavior vertically or horizontally in the viewport to expose the new pages.

16. A computer-readable medium comprising computer-executable instructions that when executed by a processor, cause the processor to perform acts of:
detecting an interaction gesture relative to content presented in a viewport of a display; and
animating an unfolding behavior of new content in response to the interaction gesture, the unfolding behavior performed along an edge of the content, in the content, or between two items of different content.

17. The computer-readable medium of claim 16, further comprising animating the unfolding behavior of the new content along a fold axis that is one of vertical, horizontal, or diagonal.

18. The computer-readable medium of claim 16, further comprising displacing some or all of the content with the new content based on the interaction gesture.

19. The computer-readable medium of claim 16, further comprising animating the unfolding behavior to visually perceive the new content as abutting the content on one edge of the content, as abutting the content on two edges, or abutting the two items of content on opposing edges of the two items of content.

20. The computer-readable medium of claim 16, further comprising animating the unfolding behavior as unfolding toward the viewport or unfolding away from the viewport.
